(19) United States
(12) Patent Application Publication
(10) Pub. No.: US 2010/0275228 A1
(43) Pub. Date: Oct. 28, 2010

(54) METHOD AND APPARATUS FOR DELIVERING MEDIA CONTENT

(75) Inventor: Krishna Prasad Panje, Bangalore (IN)

Correspondence Address: Motorola, Inc.;Law Department, 1303 East Algonquin Road, 3rd Floor, Schaumburg, IL, 60196, US

(73) Assignee: MOTOROLA, INC., Schaumburg, IL (US)

(21) Appl. No.: 12/431,118

(22) Filed: Apr. 28, 2009

(51) Int. Cl. H04N 5/91; H04N 7/173

(52) U.S. Cl. 725/38; 386/69; 725/131

(57) ABSTRACT

A method and apparatus for delivering media content. A method and apparatus for delivering media content that marks user specified events for playback such that the user would not miss significant events or events that are of interest to the user. The method and apparatus also flexibly moves the start point and/or extend the end point of the media content buffer.

### FIELD OF THE INVENTION

The present invention relates generally to customer premises equipment for viewing media content.

### BACKGROUND

Some television customer premises equipment have storage capabilities that allow users to watch live or real-time channels and perform playbacks and trick plays such as rewind, pause, slow rewind, or forward, etc. Customer premises equipment with storage capabilities may include a hard disk or other storage devices, and the playbacks and trick plays feature may be implemented with circular buffer recording. Content may be recorded on the storage device and may be used for playback purposes.

When a user is watching real-time television content he or she may want to perform playbacks or trick plays. During the playback, some interesting or significant events may have happened on the live or real-time channel. Although those events may be recorded in storage, the user may not want to search through the playback to find significant or interesting events. Moreover, if the user performs playback for a period of time, the interesting events may be overwritten in the circular buffer.

Therefore, there is a need for a system such that a user would not miss any contents that would be of his or her interest. The method and apparatus disclosed herein provides features such that a user would not miss desired events, in addition, it also provides flexible memory management for buffering.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an exemplary buffer that allows a user to perform a trick play in accordance with some embodiments of the invention.

FIG. 2 is an exemplary buffer with event markers in accordance with some embodiments of the invention.

FIG. 3 is an exemplary buffer with buffer extension in accordance with some embodiments of the invention.

FIG. 4 is an exemplary buffer with a plurality of users in accordance with some embodiments of the invention.

FIG. 5 is an exemplary buffer with event markers for a plurality of users in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to set top boxes with capabilities of recording user defined events. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of the method and apparatus for delivering media content using customer premises equipment described herein. The non-processor circuits may include, but are not limited to, a radio receiver, a radio transmitter, signal drivers, clock circuits, power source circuits, and user input devices. As such, these functions may be interpreted as steps of a method to perform recording of user defined events. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

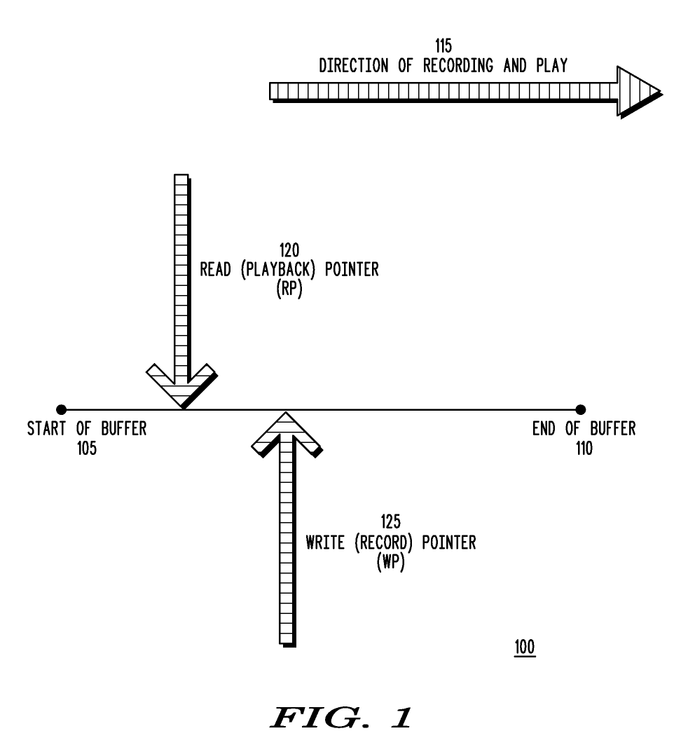

A method and apparatus for delivering media content and memory management in customer premises equipment is described herein with the drawings. In an exemplary embodiment of the method and apparatus, a circular buffer is used to record content for playback purposes. The buffer may reside in any storage device, for example, a hard drive, a flash drive, or any other storage devices. As illustrated in FIG. 1, a circular buffer has a starting point 105, an ending point 110, and the direction of the recording and play is illustrated by arrow 115. In this exemplary circular buffer, when the recording reaches the end of the buffer 110, recording may continue at the start of the buffer 105, overwriting any content that has been previously recorded in the buffer. While real-time content is being played, the write pointer 125 of the buffer records the content in the buffer for playback purposes. As the recording continues, the write pointer moves towards the direction of recording and play 115. When the user chooses to perform a playback, the read pointer 120 of the buffer may read the previously recorded content in the buffer and play the previously recorded content for the user. As the user is performing a playback, the write pointer 125 continues to record the real-time content.

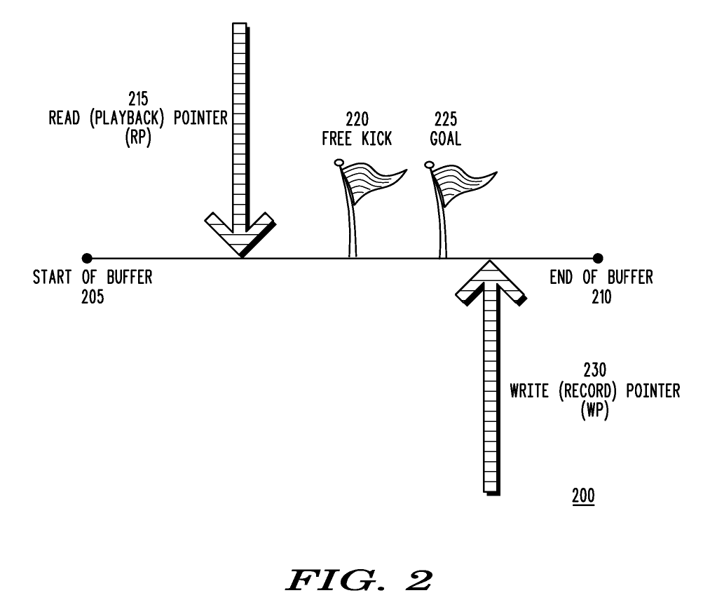

Another exemplary embodiment of the method and apparatus may be illustrated by FIG. 2. According to the method and apparatus as shown in FIG. 2, the user may enter events that correspond to content that he or she would not want to miss. For example, if the content is about a soccer game, the user may choose to enter events such as “free kick” or “goal.” The events may be specified by the user, or the events may be provided to the user. For example, if the content is related to a football game, then standard events such as “touch down” or “field goal” may be provided to the user. In the alternative, a list of standard events may be provided to the user to allow the user to specify events by selecting one or more standard events from the list. A combination of standard and user defined events may also be used. The number of events a user may define may be determined by the storage limitation of the storage device. If there is sufficient storage space, the user may define as many events as he or she wish. Other ways of limiting the number of events may also be used. For example, a parent may want to limit the number of events a child can specify. Different types of media content would have different corresponding events, for example, a music award show may have user defined events such as “best album,” “best performer,” etc.

Following FIG. 2, when the user performs a playback, the read pointer 215 may read the previously recorded content and play the previously recorded content for the user. At the same time, the write pointer 230 may continue to record the real-time content. As real-time content is being fed into the system, the system may perform checks to determine if one or more standard or user specified events have occurred.

The system may determine if content contains an event in different ways. For example, the data relating to the content may be transmitted to the system through closed captioning. If the system determines that the closed captioning contains certain terms (e.g. “goal” in a soccer game), it may be possible to determine that an event has occurred. In another example, data relating to the content may be transmitted to the system by multimedia description schemes, or other metadata methodologies. For instance, metadata may be multiplexed along with content data using packet identifiers (PIDs). An exemplary content data stream may comprise audio data, video data, and other data. Each category of data may be assigned a unique PID, such as audio data may be assigned a PID of 93, video data may be assigned a PID of 98, subtitle data may be assigned a PID of 123, and attribute data may be assigned a PID of 55. In this example, the system may look for the data with a PID assigned to attribute data, and perform a check to see if the attribute data corresponds to one or more of the user specified events.

There are many ways metadata may be transmitted to the system. Metadata may be multiplexed along with the content data, or in the alternative, the metadata may be embedded into the vertical blanking interval (VBI), text, closed captioning, or object descriptors. Any methodologies of multiplexing metadata may be used for this system.

Alternatively, other metadata structures for describing and annotating audio and video content, such as multimedia description schemes, may be used. The multimedia description schemes provide a standardized way of describing the audio and video content and content management to facilitate searching, indexing, filtering, and/or accessing. The multimedia description schemes may be in Extended Mark-up Language (XML), or any other languages.

Other languages may also be used to provide information regarding the audio and video content. For example, scene description language allows the media scene created to be described using ASCII; digital asset management allows media material to be indexed, stored, searched, and retrieved through metadata tags; and MPEG Syntax definition language allows MPEG4 objects to be described. Any method of transmitting information regarding the audio and video content may be used.

If the system check detects that a user specified event is part of the content, the event is marked in the buffer, as shown in FIG. 2. In the exemplary embodiment shown in FIG. 2, the user specified two events: “free kick,” and “goal.” When the free kick event occurs, the event “free kick” 220 is marked in the buffer. When the goal event occurs, the event “goal” 225 is marked in the buffer. The marker may be placed a period of time before the event, for example, the marker may be placed a few seconds before the event, such that the user would be able to view the few seconds leading to the occurrence of the event. Since the event markers are placed before the event, the user may perform trick play around the event. Any way of marking the event may be used. For example, the markers may be inserted into the stream that is recorded into the buffer, or alternatively, the marker may be a timestamp that is stored in a separate index file. Once the user specified events are marked, the user may request a playback of the specified events. For example, if the user wants to playback the “goal” event, the read pointer 215 may go to the “goal” event marker 225 and perform a playback.

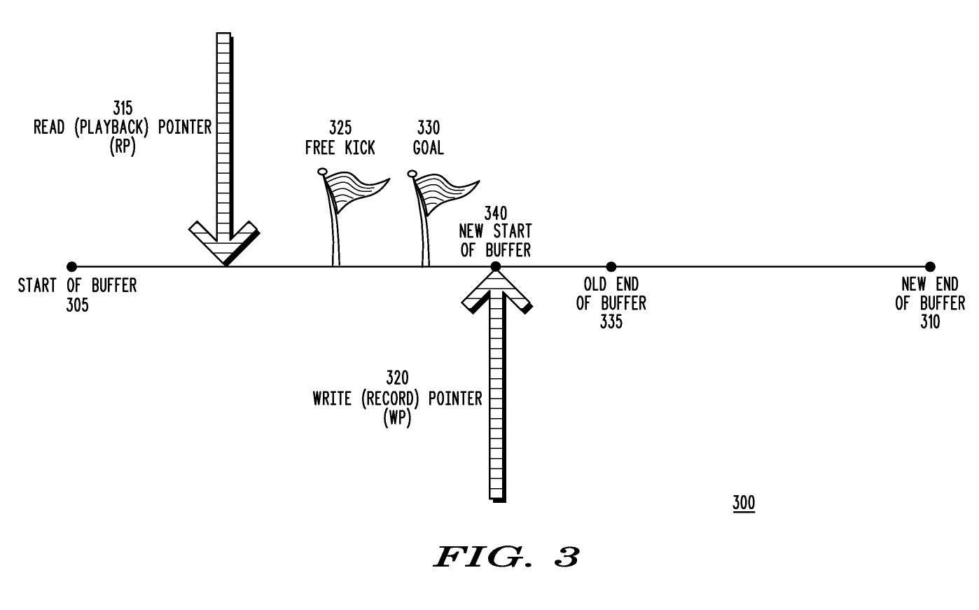

FIG. 3 illustrates the circular buffer when the end of the buffer has been reached and the recording loops back to the start of the buffer. Following FIG. 3, when the write pointer 320 reaches the end of the buffer 335, a check may be performed to determine whether there are any marked event that have not been played back by the user. If there are no event markers, or there are no marked events that have not been played back by the user, the write pointer 320 may loop back to the start of the buffer 305. However, if there are marked event that have not been played back by the user, the write pointer 320 may skip the portions where the marked events are recorded and start writing from a point after the marked events. For example, in FIG. 3, when the write pointer 320 reaches the end of the buffer 335, a check is performed to determine if there are any marked events that have not been played back by the user. In this example, the user has two marked events “free kick” 325 and “goal” 330 that the user has not yet played back. When the write pointer 320 loops back and the system determines that two marked events “free kick” 325 and “goal” 330 have not been played back by the user, the write pointer 320 may then skip the marked events 325 and 330 and start writing from a new start point 340. If the write pointer 320 skips the marked events and start writing from a new start point 340, the end of buffer 335 may be extended to a new end of buffer 310 correspondingly. For example, if the marked events occupied 10 MB of storage, the new end of buffer 310 may be extended by 10 MB. As long as the marked events 325 and 330 would not be overwritten, part or all of the extended new end of buffer 310 may or may not overlap with the start of buffer 305. In other words, the 10 MB of storage may be extended at the end of the old end of buffer 335, or alternatively, part of the 10 MB of storage, for example, 5 MB may be extended at the end of the old end of buffer 335, and the remaining 5 MB may overlap from the start of the buffer 305.

If the user has already played back the marked events, the portions in the storage to which the marked events are stored may be overwritten. For example, if the marked event “goal” 330 has been played back by the user, but the marked event “free kick” 325 has not been played back by the user, the write pointer 320 may start at the marked event “goal” 330 and overwrite the marked event “goal” 330.

In an exemplary embodiment, the circular buffer process may continue in a loop until the maximum number of specified events has been reached. That is, the marked events may not be overwritten as long as the stored marked events have not exceeded the maximum number of specified events allowed. For example, if the maximum number of specified events permitted is ten, and there are ten marked events stored in the buffer, no more events would be marked until one or more of the stored marked events are played back. Once the marked events are played back, the storage space occupied by the marked events may be overwritten by new marked events.

Alternatively, the process may also continue in a loop until the maximum allocated storage for the buffer has been reached. That is, the marked events may not be overwritten as long as the maximum amount of storage allocated for the buffer has not been reached. For example, if the maximum amount of storage allocated for the buffer is 1 GB, when the new end of buffer 310 is extended to 1 GB, no more events would be marked until one or more of the stored marked events are played back. Once the marked events are played back, the storage space occupied by the marked events may be overwritten by new marked events.

In another exemplary embodiment, multiple users may use the method and system to record the events that each of the users desires. The exemplary embodiment may be used for a family with multiple televisions or any other displays. Alternatively, the exemplary embodiment may be used by multiple users with one display. For example, different members of a family may be interested in watching the same content but the events that are of interest to each family member may be different. For instance, a family may be watching the same sporting event but different members of the family may be supporting different teams. Therefore, different family members may want to perform trick plays for different portions of the recorded content or at different times, and correspondingly may like to specify different specified events.

In an exemplary embodiment of a system for multiple users, a hub box with storage capabilities may be installed, and several terminal boxes may be installed in different locations and stream content from the hub box. For example, a hub box may be installed in a living room, and a number of terminal boxes may be installed in multiple bedrooms to support multiple television sets in the same house. The terminal boxes need not have storage capabilities, although the terminal boxes may have storage capabilities for additional functionalities. If the terminal boxes have no storage capabilities, the buffer may reside in the hub box, and the terminal boxes may obtain stored content from the hub box.

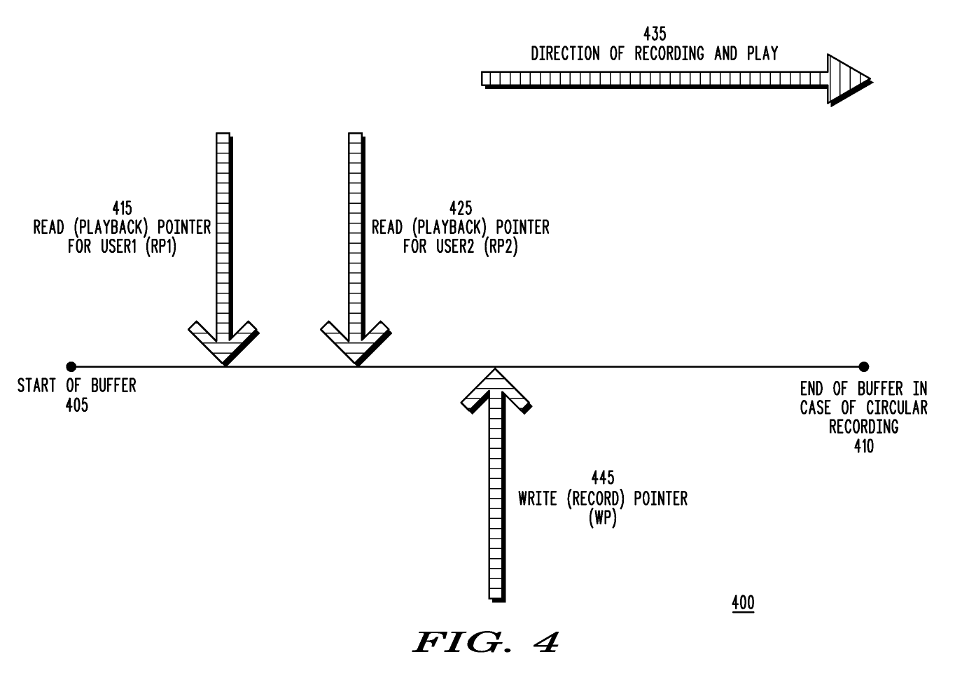

Another exemplary embodiment may be illustrated by FIG. 4. In this exemplary embodiment, multiple users watching the same content may perform different playbacks or trick plays from different parts of the buffer. For example, if two users are watching a football game, one user may have missed one part of the game and may want to perform a playback or trick play for that part of the game, while another user may have missed another part of the game and may want to perform a playback or trick play for that part of the game. As illustrated in FIG. 4, a circular buffer has a starting point 405, an ending point 410, and the direction of the recording and play is illustrated by element 435. While real-time content is being played, the write pointer 445 of the buffer records the content in the buffer for playback purposes. As the recording continues, the write pointer moves towards the direction of recording and play 435. When a first user choose to perform a playback, the first read pointer 415 of the buffer may read the previously recorded content in the buffer and play the previously recorded content for the first user. When a second user choose to perform a playback, the second read pointer 425 may read the previously recorded content in the buffer and play the previously recorded content for the second user. As shown in FIG. 4, the read pointers 415 and 425 may read from different portions of the buffer, thus allowing different users to playback different portions of the content. As the users are performing a playback, the write pointer 445 continues to record real-time content.

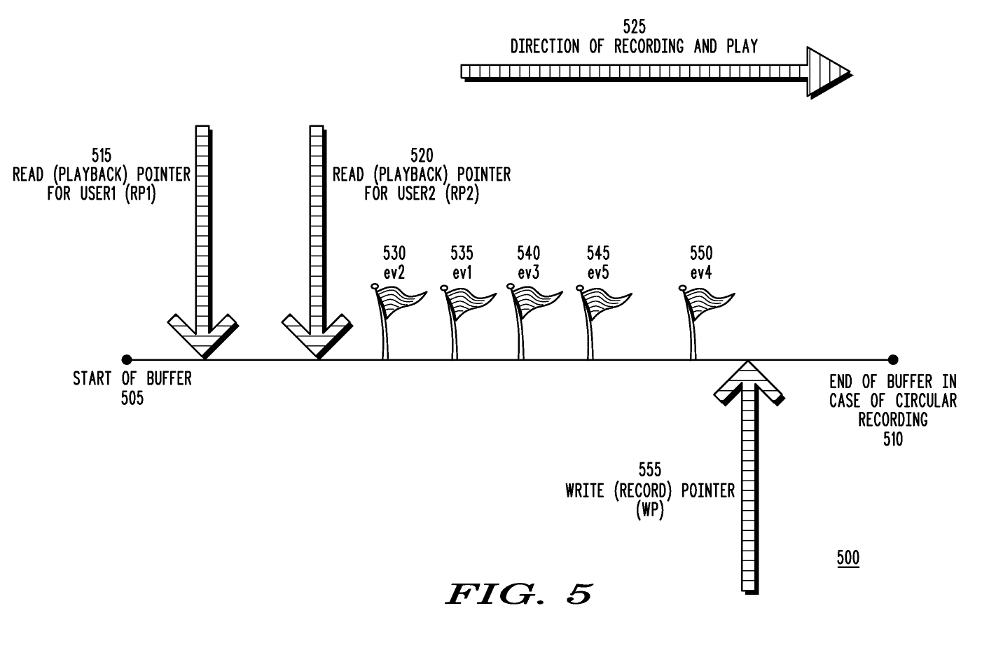

Another exemplary embodiment of the method and apparatus may be illustrated by FIG. 5. According to the method and apparatus as shown in FIG. 5, the first user may enter events of the content that he or she would not want to miss, and the second user may enter events of the content that he or she would not want to miss. Alternatively, the events may be provided by the users as standard events that may be associated with particular types of content. For example, the first user may specify events “ev1” 535 and “ev4” 550, and the second user may specify events “ev2” 530, “ev3” 540 and “ev5” 545.

Following FIG. 5, when the first user performs a playback, the read pointer for the first user 515 may read the previously recorded content and play the previously recorded content for the first user. At the same time, the write pointer 555 may continue to record real-time content. As additional real-time content is being fed into the system, the system may perform checks to determine if the additional real-time content contains events specified by the first user. Since the second user has not yet performed a playback, i.e. the second user is still watching real-time content, the system does not perform checks to determine if the additional real-time content contains events specified by the second user. However, in other implementations, checks to determine if the additional real-time content contains events specified by a user may be performed even though the user has not performed a playback.

If the check reveals that one or more events specified by the first user have occurred, the events may be marked in the buffer, as shown in FIG. 5. In FIG. 5, the first user specified two events, “ev1” and “ev4”. When the event “ev1” has occurred, the event “ev1” 535 is marked in the buffer with an indicator that the event belongs to the first user. When the event “ev4” has occurred, the event “ev4” 550 is marked in the buffer with an indicator that the event belongs to the first user. An association between the first user and the marked events may also be made, thus allowing the system to identify the events that belong to a particular user.

Following FIG. 5, if the second user performs a playback, the read pointer for the second user 520 may read the previously recorded content and play the previously recorded content for the second user. At the same time, the write pointer 555 may continue to record additional real-time content. As real-time content is being fed into the system, the system may perform checks to determine if the additional real-time content contains events specified by the second user. If more than one user are performing play backs or trick plays, checks may be performed to determine if the additional real-time content contains events specified by the users performing playbacks or trick plays. Alternatively, if more than one user are performing playbacks or trick plays, the system may perform checks to determine if the additional real-time content contains events specified events by any and all of the users, including users that are not performing playbacks or trick plays.

If the check reveals that the additional real-time content contains events specified by the second user, the event is marked in the buffer, as shown in FIG. 5. For example, in FIG. 5, the second user specified three events, “ev2,” “ev3,” and “ev5”. If the additional real-time content contains events specified event “ev2”, the event “ev2” 530 is marked in the buffer with an indicator that the event belongs to the second user. If the additional real-time content contains event “ev3”, the event “ev3” 540 is marked in the buffer with an indicator that the event belongs to the second user. If the additional real-time content contains event “ev5”, the event “ev5” 550 is marked in the buffer with an indicator that the event belongs to the second user. Similarly, associations between the second user and events “ev2,” “ev3,” and “ev5” may be made such that the system can identify events “ev2,” “ev3,” and “ev5” belong to the second user.

When the user is finished with the trick play and wants to view the content that the user has missed during the time trick play is performing, the user may have many ways to view the missed content. For example, the user may simply continue viewing from the point in the real-time content when the user stopped viewing the real-time content and started performing trick play. Alternatively, the user may just view the events he or she specified.

For example, if the first user decides to view the events he or she specified, the first user may request a playback of the specified events because the events specified by the first user are marked. For example, if the first user wants to playback the event “ev1” 535, the read pointer for the first user 515 may go to the “ev1” event 535 and perform a playback. Similarly, if the second user wants to playback the event “ev2” 530, the read pointer for the second user 530 may go to the “ev2” event 530 and perform a playback.

In another exemplary embodiment, the apparatus may provide a remote control with one or more user-specific buttons for users to get content portions related to the events specified by a particular user. For example, a remote control may be provided for a terminal box for the first user and another remote control may be provided for a terminal box for the second user. If the first user presses a user-specific button on the remote control, the terminal box of the first user may communicate with the hub box, and then present a menu of events specified by the first user. For example, the menu may list “ev1” and “ev4.” The events specified by other users may not be presented to the first user because the first user has not specified those events.

In another exemplary embodiment, the apparatus may provide a remote control with one or more buttons for users to specify events and playback specified events. The buttons may launch one or more menus that enable different users to specify events and to playback recorded specified events. In this exemplary embodiment, buttons specific to each user are not required and different users navigate through menus using the remote control to specify and play that user's events.

Alternatively, in another exemplary embodiment, a plurality of users may be watching a plurality of different channels, and each user may specify events for the particular content that he or she is viewing.

If all the users are using the same display, for example if all the users are using a single television, a hub box or customer premises equipment may be connected to the single television. A plurality of windows may be shown on the same television for a plurality of users to perform playbacks or trick plays and to playback events specified by different users. The real-time content may be continuously displayed on the main display window. For example, if a first user and a second user are using one television, two additional display windows may be displayed on the main display window. The main display window may continue to display real-time content, and one of the additional display windows may be displayed for the first user to perform playbacks or trick plays and to playback events specified by the first user. Similarly, another additional display window may be displayed for the second user to perform playbacks or trick plays and to playback events specified by the second user.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method of delivering media content to a user, comprising:
providing an interface for a user to specify one or more events;
providing real-time media content to the user;
recording said real-time media content in a circular buffer having an end point; and
determining whether the real-time media content contains one or more user specified events and marking said user specified events in the circular buffer;
wherein recording real-time media content in the buffer comprises skipping over and not overwriting unviewed marked user specified events when recording contents in the circular buffer.

2. The method as recited in claim 1, further comprising extending the ending point of the circular buffer to a new ending point if there are unviewed marked user specified events in the circular buffer.

3. The method as recited in claim 1, further comprising:
determining whether the one or more marked user specified events in the circular buffer have been viewed and wherein recording real-time media content in the circular buffer comprises overwriting the marked user specified events in the buffer that have been viewed.

4. The method as recited in claim 1, wherein determining whether the real-time media content contains one or more user specified events and marking said user specified events in the circular buffer occurs as the real-time content is being provided to said user, as the real-time media content is being recorded to the circular buffer, or after said user has performed a playback function.

5. The method as recited in claim 1, wherein marking said user specified events in the buffer comprises recording a time stamp corresponding to the beginning of the event or a time stamp corresponding to a point of time before the beginning of the event.

6. The method as recited in claim 1, further comprising:
marking the user specified events in the buffer using one or more index files.

7. A method of delivering media content to a plurality of users, comprising:
providing at least one interface for a plurality of users to specify one or more events for each user;
providing real-time media content to said plurality of users;
recording real-time media content in a circular buffer;
determining whether the real-time media content contains one or more events specified by any of said plurality of users, marking said events in said circular buffer, and associating each marked event with an identity of one of said plurality of users; and
providing an interface that allows each of said plurality of users to select marked events associated with said user for playback,
wherein recording real-time media content in the buffer comprises skipping over and not overwriting unviewed marked user specified events when recording contents in the circular buffer.

8. The method as recited in claim 7, wherein recording real-time media content in the circular buffer further comprises extending the ending point of the circular buffer to a new ending point if there are unviewed marked user specified events in the circular buffer.

9. The method as recited in claim 7, further comprising:
determining whether the one or more marked user specified events in the circular buffer have been viewed and wherein recording real-time media content in the circular buffer comprises overwriting the marked user specified events in the buffer that have been viewed.

10. The method as recited in claim 7, wherein marking said user specified events in the buffer comprises recording a time stamp corresponding to the beginning of the event or to a period of time before the beginning of the event.

11. The method as recited in claim 7, further comprising:
marking the user specified events in the buffer using one or more index files.

12. The method as recited in claim 7, further comprising providing an interface to allow each of said plurality of users to select playback of marked events associated with each user.

13. The method as recited in claim 12, wherein recording real-time media content comprises recording said content in a buffer in a hub box; and wherein said interface to allow each of said plurality of users to select playback are a plurality of terminal boxes.

14. The method as recited in claim 13, further comprising:
providing real-time media content in a main display window; and
providing playback of a plurality of user selected marked events in a plurality of display windows overlaying the main display window.

15. A system for delivering media content to a user, comprising:
a receiver for receiving real-time media content;
a non-volatile memory for buffering real-time media content;
an output interface for providing media content to a user;
an input interface for a user to specify one or more events; and
a processor for determining whether the real-time media content contains one or more user specified events;
wherein, the processor marks the user specified events in the memory if it determines that the real-time media content contains one or more user specified events, and
wherein the processor determines whether there are one or more marked user specified events in the buffer, and wherein the processor causes additional real-time media content recorded in the buffer not to overwrite marked user specified events in the buffer, if said processor determines there are one or more marked user specified events in the buffer.

16. The system of claim 15, wherein the processor determines if marked user specified events in the buffer have been viewed, and wherein the processor causes additional real-time media content recorded in the buffer to overwrite marked user specified events in the buffer, if said processor determines that said marked user specified event has been viewed.

17. The system of claim 15, wherein if the processor determines there are one or more marked user specified events in the buffer, the processor extends the ending point of the circular buffer to a new ending point.

18. The system of claim 16, further comprising
at least one hub box, wherein said hub box comprises said non-volatile memory; and
a plurality of terminal boxes operatively connected to said hub box, wherein each of said terminal boxes comprises one of said input interface for a user to specify one or more events, and wherein each of said terminal boxes comprises an interface that allows a user to retrieve for playback events stored on said memory of said hub box.

19. The system of claim 18, further comprising:
a plurality of read pointers, said plurality of read pointers enabling reading a plurality of events simultaneously; and
one or more output interfaces for providing media content read from the plurality of read pointers to a plurality of users.

20. The system as recited in claim 18, further comprising:
at least one display comprising:
at least one main display window for displaying real-time content; and
a plurality of display windows overlaying said main display window, each of said plurality of display windows displaying a user selected event.
